(19) United States
(12) Patent Application Publication
(10) Pub. No.: US 2005/0204111 A1
(43) Pub. Date: Sep. 15, 2005

(54) Command scheduling for dual-data-rate two (DDR2) memory devices

(76) Inventor: Rohit Natarajan, Sunnyvale, CA (US)

Correspondence Address: Jan Little-Washington;BLAKELY, SOKOLOFF, TAYLOR & ZAFMAN LLP, Seventh Floor, 12400 Wilshire Boulevard, Los Angeles, CA, 90025, US

(21) Appl. No.: 10/798,600

(22) Filed: Mar. 10, 2004

(51) Int. Cl. G06F 12/00

(52) U.S. Cl. 711/167; 711/5

(57) ABSTRACT

Embodiments of the present invention include an integrated circuit that has eight queues to receive commands for a memory device, the memory device having four banks, the eight configurable queues having a first queue and a second queue to map to a first bank. The integrated circuit also includes logic to determine the last type of command de-queued, determine a bank designated to receive the next command to be de-queued, inspect the first and the second queues for a type of command matching the last type of command de-queued, de-queue the command that matches the last type of command de-queued, and send the de-queued command to the designated bank. In one embodiment, the designated bank is the next sequential bank after a bank to receive a last de-queued command.

### BACKGROUND

1. Field

Embodiments of the present invention relate to memory circuits and particularly to scheduling memory commands.

2. Discussion of Related Art

A common computer system includes a processor coupled to a memory controller via a front side bus. The memory controller is coupled to one or more memory modules via a memory bus. The memory modules have memory devices inserted into them. The processor or other device coupled to the memory controller sends requests to read from or write to the memory devices. The memory controller processes the commands.

A group of key memory module vendor companies, manufacturing companies, and user companies proposed a standard to ensure compatibility among memory devices. The group is called the Joint Electronic Device Engineering Council (JEDEC) and one of the memory devices originally considered back in 1997 is called the “double data rate” (DDR) memory. JEDEC Standard No. 79C, “Double Data Rate (DDR) SDRAM Specification,” published March 2003, defines the minimum set of requirements for JEDEC compliant DDR Synchronous Dynamic Random Access Memory (SDRAM) devices of sixty-four megabyte (64 Mb) through one gigabyte (1 Gb) ×4/×8/×X16.

Today, DDR2 memory devices are being designed in accordance with the JEDEC Standard No. 79-2A, “DDR2 SDRAM Specification,” published January 2004, which defines the minimum set of requirements for JEDEC compliant DDR SDRAM devices of two hundred fifty-six megabyte (256 MB) through four gigabyte (4 Gb) ×4/×8/×16. Designers face challenges, however, to optimize computer and memory system performance while attempting to comply with the DDR2 SDRAM Specification.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a high-level block diagram of a computer system according to an embodiment of the present invention;

FIG. 2 is a flowchart illustrating a command-scheduling algorithm according to an embodiment of the present invention;

FIG. 3 is a schematic diagram showing command-scheduling logic according to an embodiment of the present invention;

FIG. 4 is a high-level block diagram showing a four-bank single-sided memory configuration according to an embodiment of the present invention;

FIG. 5 is a high-level block diagram showing a four-bank double-sided memory configuration according to an embodiment of the present invention;

FIG. 6 is a schematic diagram illustrating access to side 0 and side 1 of a memory module according to an embodiment of the present invention;

FIG. 7 is a high-level block diagram showing an eight-bank single-sided memory configuration according to an embodiment of the present invention;

FIG. 8 is a high-level block diagram showing an eight-bank double-sided memory configuration according to an embodiment of the present invention;

FIG. 9 is a high-level block diagram showing a communication network according to an embodiment of the present invention;

FIG. 10 is a high-level block diagram of a network processor according to an embodiment of the present invention; and

FIG. 11 is a high-level block diagram of a network device according to an embodiment of the present invention.

### DETAILED DESCRIPTION OF THE ILLUSTRATED EMBODIMENTS

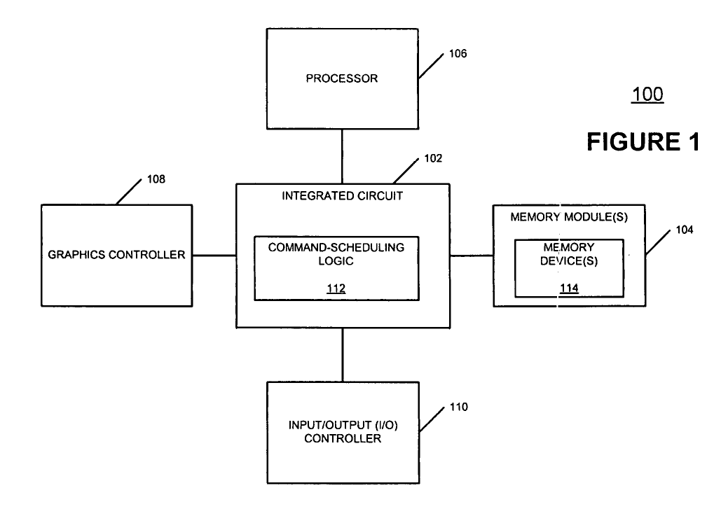

FIG. 1 is a high-level block diagram of a computer system 100 according to an embodiment of the present invention that optimizes performance while complying with at least the DDR2 SDRAM Specification. The system 100 includes an integrated circuit 102 coupled to one or more memory modules 104, a processor 106, a graphics controller 108, and an input/output (I/O) controller 110. The integrated circuit 102 includes command-scheduling logic 112. The memory module 104 includes one or more memory devices 114.

The integrated circuit 102 can be any device (e.g., processor, memory controller) to communicate with the memory module 104 or the memory device 114 when other components in the system 100 are attempting to read from or write to the memory device 114. For example, the integrated circuit 102 can interpret commands from the processor 106, graphics controller 108, and/or I/O controller 110 in order to locate data locations, addresses, etc., when these components are attempting to access the memory device 114. The integrated circuit 102 also can perform functions of controlling and monitoring the status of the data lines, error checking, etc.

The memory module 104 can be a small substrate into which memory devices, such as the memory device 114, can be inserted. The memory module 104 is not limited to any particular type of memory module. In one embodiment, the memory module 104 can be a single in-line memory module (SIMM) in which signal and power pins are on a single side of the substrate. In an alternative embodiment, the memory module 104 is a dual in-line memory module (DIMM) in which signal and power pins are on a both sides of the substrate. After reading the description herein, a person of ordinary skill in the relevant art will readily recognize how to implement embodiments of the present invention for various other types of memory modules.

In one embodiment, the memory module 104 can be a single-sided memory module. In this embodiment of the present invention, memory devices 114 are positioned only on one side of the memory module 104. In an alternative embodiment, the memory module 104 can be a double-sided memory module. In this embodiment of the present invention, memory devices 114 are positioned on two sides of the memory module 104.

The processor 106 can be any suitable device that performs functions of executing programming instructions including implementing embodiments of the present invention. For example, the integrated circuit 106 can be a processor of the Pentium® processor family available from Intel Corporation of Santa Clara, Calif.

The graphics controller 108 can be any suitable device that performs conventional functions of receiving commands and data and generating display signals (e.g., in RGB format). Graphics controller technology also is well known.

The I/O controller 110 can be any suitable device that performs conventional functions of interfacing the components in the system 100 with peripheral devices (e.g., a peripheral component interconnect (PCI) bus controller, Ethernet controller, etc.). I/O controller technology also is well known.

The memory device 114 can be any suitable SDRAM device that performs the functions of storing data (pixels, frames, audio, video, etc.) and software (control logic, instructions, code, computer programs, etc.) for access by other components. The memory device 114 is not limited to any particular type of SDRAM device. In embodiments of the present invention, the memory device 114 can be a DDR SDRAM device, a DDR2 SDRAM device, a DDR3 SDRAM device, etc. The memory device 114 also can be a non-synchronous DRAM device. After reading the description herein, a person of ordinary skill in the relevant art will readily recognize how to implement embodiments of the present invention for various other types of memory devices.

In embodiments of the present invention, the memory device 114 can be logically partitioned into several internal banks. In one embodiment, the memory device 114 can be partitioned into four banks. In an alternative embodiment, the memory device 104 can be partitioned into eight banks.

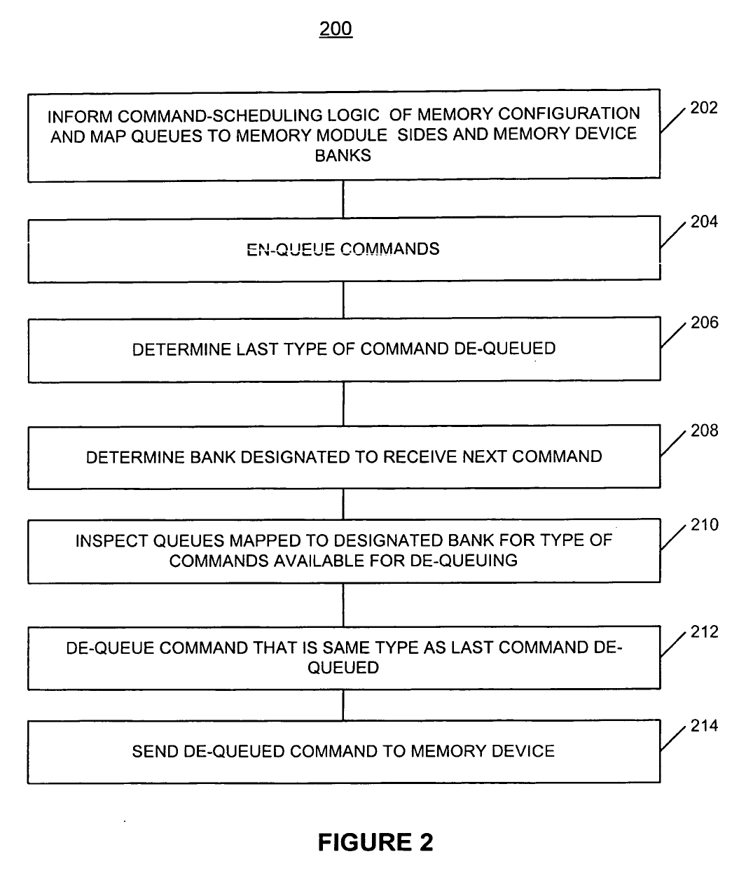

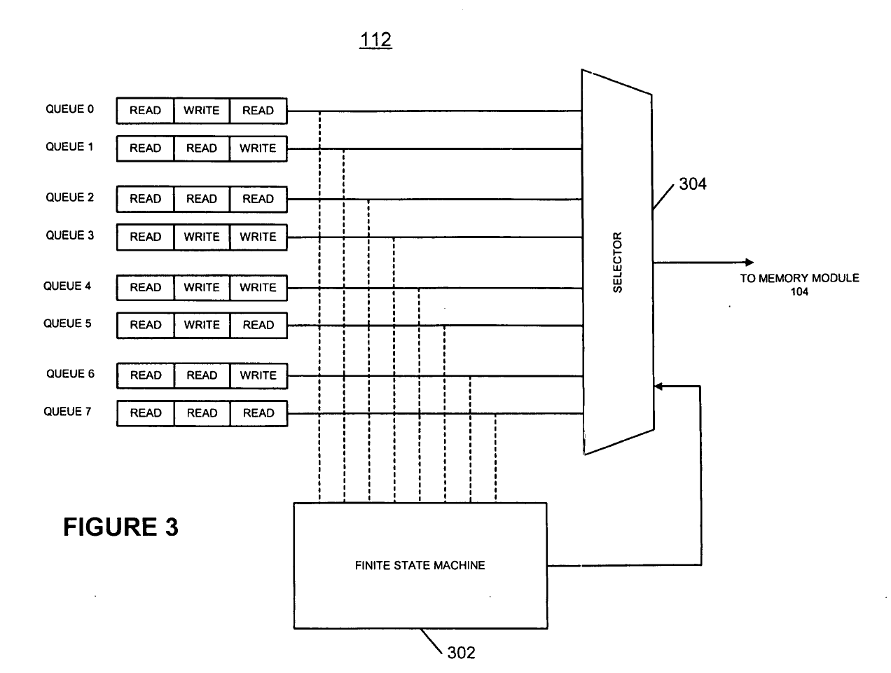

FIG. 2 is a flowchart illustrating a command-scheduling algorithm 200 according to an embodiment of the present invention that can be implemented by the command scheduling logic 112. FIG. 3 is a schematic diagram showing the command-scheduling logic 112 in greater detail according to an embodiment of the present invention.

The command-scheduling logic 112 includes N configurable queues (e.g., eight queues: queue 0, queue 1, queue 2, queue 3, queue 4, queue 5, queue 6, and queue 7) whose outputs are coupled to a finite state machine 302 and a selector 304. The finite state machine 302 is coupled to the selector 304 and the selector 304 is coupled to the memory module 104. Finite state machines and selector (e.g., multiplexer) are known and after reading the description herein, a person of ordinary skill in the relevant art will readily recognize how to implement the finite state machine 302 and selector 304 according to embodiments of the present invention.

Referring back to FIG. 2, in a block 202, the command-scheduling logic 112 is informed of the memory configuration of the memory module 104 and the memory device 114 and configures, i.e., maps the queues to the memory module 104 sides and the memory device 114 banks as appropriate. In one embodiment, the memory module 104 has serial presence detect (SPD) interface that includes information about the type of memory, topology, etc., and the processor 106 and/or software running on the processor 106 reads the information, writes the information to a control register in the integrated circuit 102.

In one embodiment, the memory module 104 is a single-sided memory module and the memory device 114 has M (e.g., four) banks. In this embodiment, queue 0 and queue 1 both map to bank 0 of the memory device 114. Queue 2 and queue 3 both map to bank 1 of the memory device 114. Queue 4 and queue 5 both map to bank 2 of the memory device 114. Queue 6 and queue 7 both map to bank 3 of the memory device 114.

Memory device 114 addresses are chosen such that the desired queues map to the desired banks. After reading the description herein a person of ordinary skill in the relevant art would readily recognize how to select address bits so that queue 0 and queue 1 map to bank 0, queue 2 and queue 3 map to bank 1, queue 4 and queue 5 map to bank 3, and queue 6 and queue 7 map to bank 4.

In a block 204, several commands (read, write) are en-queued in the queues (queue 0, queue 1, queue 2, queue 3, queue 4, queue 5, queue 6, and queue 7). A “read” command is a request from a component in the system 100 to read from the memory device 114. A “write” command is a request from a component in the system 100 to write to the memory device 114.

In one embodiment, the queues (queue 0, queue 1, queue 2, queue 3, queue 4, queue 5, queue 6, and queue 7) receive a mixture of read commands and write commands in random short bursts. Of course, accesses to the memory device 114 can have other patterns. After reading the description herein, a person of ordinary skill in the relevant art will readily recognize how to implement embodiments of the present invention for other access patterns.

In a block 206, the finite state machine 302 determines the last type of command de-queued.

In a block 208, the finite state machine 302 determines the bank in the memory device 114 that is designated to receive the next command. In one embodiment of the present invention, the bank in the memory device 114 designated to receive the next command is the next sequential bank. That is, if bank 0 was the last bank to receive a command, then the finite state machine 302 determines that bank 1 is designated to receive the next command. In an alternative embodiment, the bank in the memory device 114 designated to receive the next command is not the next sequential bank.

In a block 210, the finite state machine 302 inspects the two queues that are mapped to the designated bank in the memory device 114 to determine the type of commands that are available for de-queuing.

In a block 212, the selector 304 in cooperation with the finite state machine 302 de-queues the command in the queue mapped to the designated bank in the memory device 114 that is the same type as (i.e., it matches) the last command de-queued. For purposes of explanation, suppose that the last command de-queued was a write command and that the bank designated to receive the next command is bank 0. In this scenario, the selector 304 in cooperation with the finite state machine 302 de-queues a write command from one of the two queues mapped to bank 0 if there is a write command in one of the queues because it is the same type of command that was de-queued last.

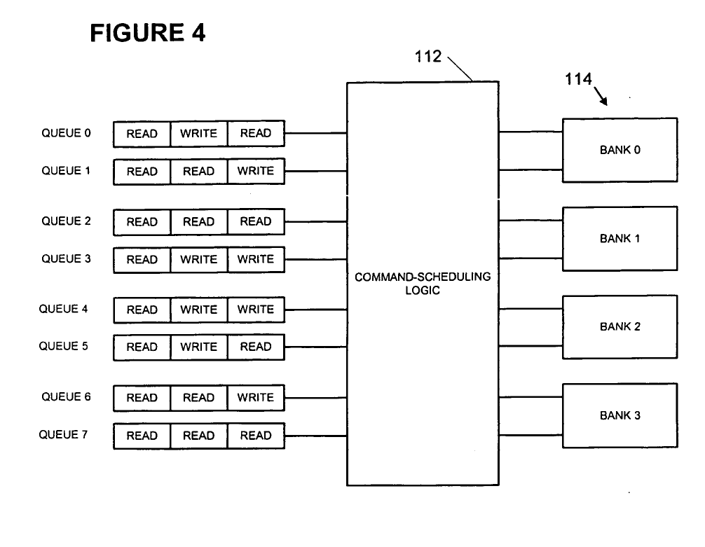

FIG. 4 is a high-level block diagram showing a memory configuration according to an embodiment of the present invention in which the memory module 104 is a single-sided memory module and the memory device 114 has four banks (bank 0, bank 1, bank 2, and bank 3). In this embodiment, and using the same scenario described above, the selector 304 in cooperation with the finite state machine 302 de-queues the write command in queue 1 and sends the write command to bank 0.

Suppose, in the alternative, that the last command de-queued was a read command, that the last bank to receive a command was bank 3, and that banks are being designated to receive commands in a sequential manner. In this alternative scenario, the selector 304 in cooperation with the finite state machine 302 de-queues the read command in queue 0 and in a block 214 sends the read command to bank 0.

Normally, when a memory device has four banks only one queue maps to a bank. Implementing the command-scheduling algorithm 200 according to embodiments of the present invention doubles the probability that a command is available for de-queuing that is the same type as the last command de-queued. The doubled probability greatly increases the success rate of the command-scheduling algorithm 200 and results in improved memory device 114 utilization.

In embodiments of the invention in which commands do not have to be processed in a particular order, the integrated circuit 102 re-orders the commands. In embodiments of the present invention, in which commands have to be processed in a particular order, the integrated circuit 102 prevents Read-after-Write, Write-after-Write, and Write-after-Read hazards by ensuring that requests to the same address (which therefore have a data dependency on each other) are processed in order.

Although the operations of the command-scheduling algorithm 200 are described as multiple discrete blocks performed in turn in a manner that is most helpful in understanding embodiments of the invention, the order in which they are described should not be construed to imply that these operations are necessarily order dependent or that the operations be performed in the order in which the blocks are presented.

Of course, the command-scheduling algorithm 200 is only an example process and other processes can be used to implement embodiments of the present invention. A machine-accessible medium with machine-readable instructions thereon can be used to cause a machine (e.g., a processor) to perform the command-scheduling algorithm 200.

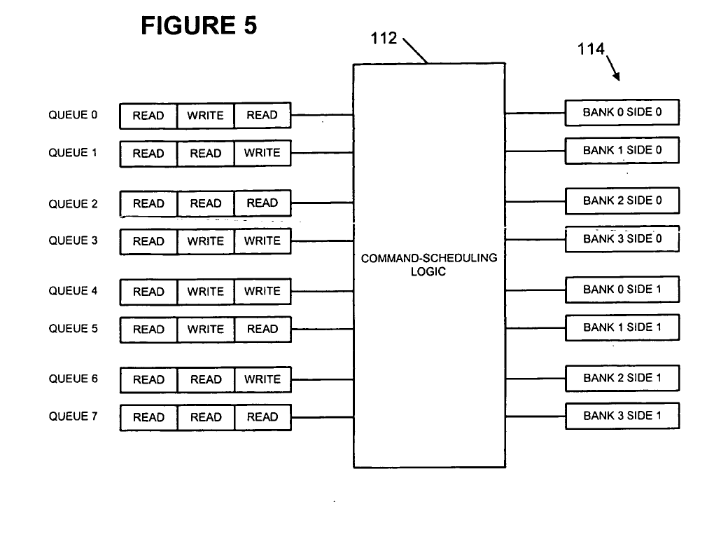

FIG. 5 is a high-level block diagram showing a memory configuration according to an embodiment of the present invention in which the memory module 104 is a double-sided memory module and the memory device 114 has four banks (bank 0, bank 1, bank 2, and bank 3). In this embodiment, queue 0 maps to bank 0, side 0 of the memory device 114, queue 1 maps to bank 1, side 0 of the memory device 114, queue 2 maps to bank 2, side 0 of the memory device 114, queue 3 maps to bank 3 side 0 of the memory device 114, queue 4 maps to bank 0, side 1 of the memory device 114, queue 5 maps to bank 1 side 1 of the memory device 114, queue 6 maps to bank 2, side 1 of the memory device 114, and queue 7 maps to bank 3, side 1 of the memory device 114.

Memory device 114 addresses are chosen such that the desired queues map to the desired banks. After reading the description herein a person of ordinary skill in the relevant art would readily recognize how to select address bits so that appropriate queues map to the appropriate banks of this and other embodiments.

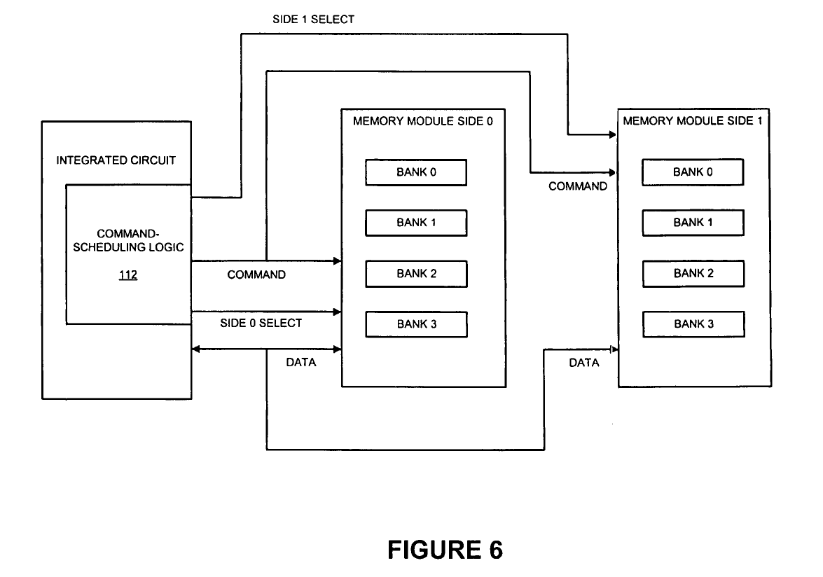

The memory configuration illustrated in FIG. 5 functions similar to the memory configuration illustrated in FIG. 4. Access to side 0 and side 1 of the memory module 104 is depicted in FIG. 6, in which data and command lines are coupled between the integrated circuit 102 and both sides of the memory module 104. A side select 0 signal is coupled to select side 0 when a command is to be sent to side 0 and a side select 1 signal is coupled to select side 1 when a command is to be sent to side 1. Techniques for selecting between memory module sides are well known and will not be described further herein.

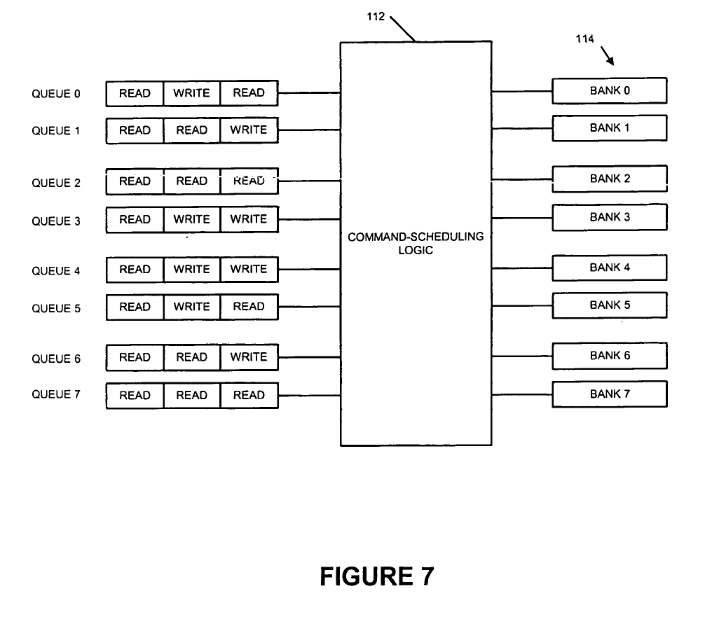

Although embodiments of the present invention have been described with reference to the memory module 104 being a single-sided or double-sided memory module and the memory device 114 having four banks, embodiments of the present invention are not so limited. For example, in one embodiment, the memory module 104 is a single-sided memory module and the memory device 114 has eight banks. FIG. 7 is a high-level block diagram showing a memory configuration according to an embodiment of the present invention in which the memory module 104 is a single-sided memory module and the memory device 114 has eight banks (bank 0, bank 1, bank 2, bank 3, bank 4, bank 5, bank, 6, and bank 7). In this embodiment, queue 0 maps to bank 0, queue 1 maps to bank 1, queue 2 maps to bank 2, queue 3 maps to bank 3, queue 4 maps to bank 4, queue 5 maps to bank 5, queue 6 maps to bank 6, and queue 7 maps to bank 7 of the memory device 114.

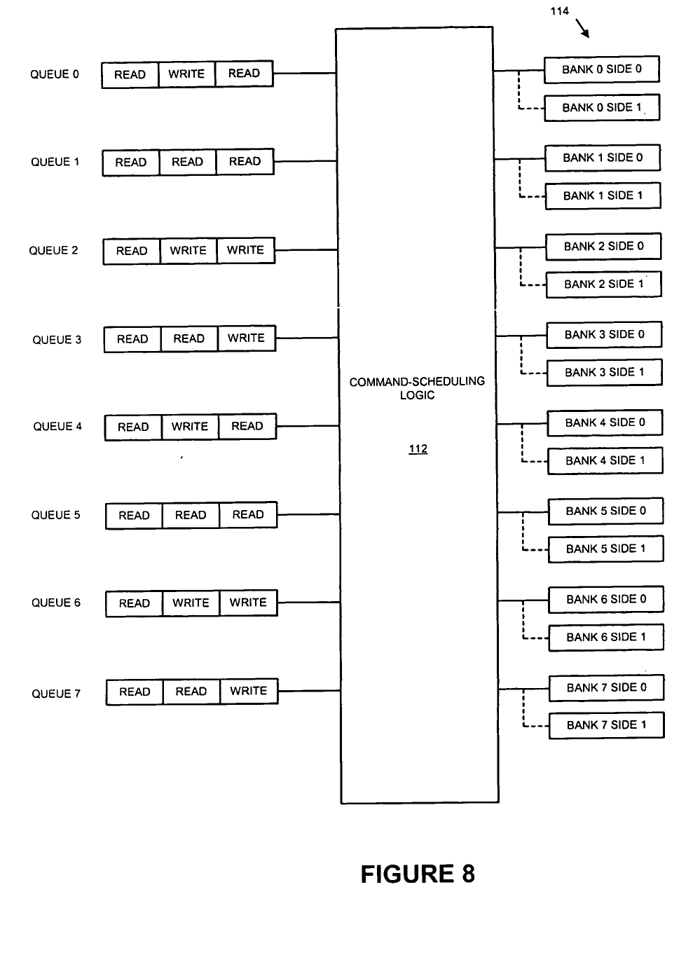

In an alternative embodiment, the memory module 104 is a double-sided memory module and the memory device 114 has eight banks such that the components in the system 100 effectively have access to sixteen banks, i.e., side 0 has eight banks, and side 1 has 8 banks. FIG. 8 is a high-level block diagram showing a memory configuration according to an embodiment of the present invention in which the memory module 104 is a double-sided memory module and the memory device 114 has eight banks (bank 0, bank 1, bank 2, bank 3, bank 4, bank 5, bank, 6, and bank 7). In this embodiment, queue 0 maps to bank 0 side 0 and bank 0 side 1, queue 1 maps to bank 1 side 0 and bank 1 side 1, queue 2 maps to bank 2 side 0 and bank 2 side 1, queue 3 maps to bank 3 side 0 and bank 3 side 1, queue 4 maps to bank 4 side 0 and bank 4 side 1, queue 5 maps to bank 5 side 0 and bank 5 side 1, queue 6 maps to bank 6 side 0 and bank 6 side 1, and queue 7 maps to bank 7 side 0 and bank 7 side 1 of the memory device 114.

In other embodiments, the integrated circuit 102 can have multiple (N) queues (e.g., sixteen, thirty-two, etc), the memory module 104 can be multiple-sided (e.g., four), and the memory device 114 can have multiple (M) banks (e.g., sixteen, thirty-two, etc). After reading the description herein, a person of ordinary skill in the relevant art will readily recognize how to implement embodiments of the present invention using multiple sided memory modules and multiple memory device banks.

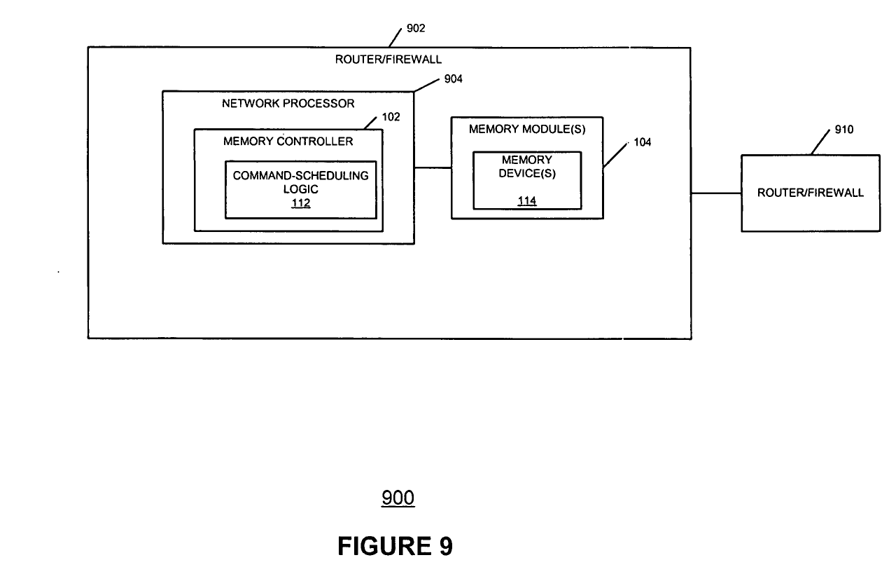

FIG. 9 is a high-level block diagram of a communication network 900 according to an alternative embodiment of the present invention that optimizes performance while complying with at least the DDR2 SDRAM Specification. The network 900 includes a router/firewall 902. The router firewall 902 includes a network processor 904 coupled to the memory module(s) 104. The router/firewall is coupled to a second router/firewall 910. The network processor includes the integrated circuit 102, which in this embodiment is a memory controller. The memory controller 102 includes the command-scheduling logic 112. The memory module 104 includes the memory device(s) 114.

In embodiments of the present invention, the router/firewall 902 performs its conventional functions of protecting the resources within the network (not shown) of which the router/firewall 902 is a portion from users within the network (not shown), or other networks, of which the router/firewall 910 is a portion. The router/firewall 902 also performs its conventional functions of determining the next node to which information is to be forwarded. The router/firewall 910 functions similarly to the router/firewall 902. The network processor 904 can be a task-specific processor, such as classification and/or encryption engine, but is not so limited. Alternatively, the network processor can be a general-purpose packet or communications processor.

The network processor 904 can be an Intel® Internet eXchange network Processor (IXP). Other network processors suitable for implementing embodiments of the present invention have different designs. After reading the description herein, a person of ordinary skill in the relevant art will readily recognize how to implement embodiments of the present invention on various network processors.

In addition to the memory controller 102, the network processor 904 can include a known or proprietary media interface (e.g., Ethernet, Synchronous Optical Network (SONET), High-Level Data Link Control (HDLC) framers), known or proprietary switch fabric (e.g., HyperTransport, Infiniband, PCI-X, Packet-Over-SONET, RapidIO, and Utopia compatible switch fabric), known or proprietary packet processors (e.g., Reduced Instruction Set Computing 9RISCO processors tailored for packet processing), one or more known or proprietary cores (e.g., StrongARM® Xscale processors), and/or other a known or proprietary a circuitry (e.g., hash engine, scratch pad, etc.) that perform their conventional functions.

Embodiments of the present invention can be implemented using hardware, software, or a combination thereof. In implementations using software, the software can be stored on a machine-accessible medium.

A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable and non-recordable media (e.g., read only memory (ROM), random access memory (RAM), magnetic disk storage media, optical storage media, flash memory devices, etc.), as well as electrical, optical, acoustic, or other form of propagated signals (e.g., carrier waves, infrared signals, digital signals, etc.).

The above description of illustrated embodiments of the invention is not intended to be exhaustive or to limit embodiments of the invention to the precise forms disclosed. While specific embodiments of, and examples for, the invention are described herein for illustrative purposes, various equivalent modifications are possible within the scope of embodiments of the invention, as those skilled in the relevant art will recognize. These modifications can be made to the embodiments of the invention in light of the above detailed description.

In the above description, numerous specific details, such as particular processes, materials, devices, and so forth, are presented to provide a thorough understanding of embodiments of the invention. One skilled in the relevant art will recognize, however, that the embodiments of the present invention can be practiced without one or more of the specific details, or with other methods, components, etc. In other instances, well-known structures or operations are not shown or described in detail to avoid obscuring the understanding of this description.

Reference throughout this specification to “one embodiment” or “an embodiment” means that a particular feature, structure, process, block, or characteristic described in connection with an embodiment is included in at least one embodiment of the present invention. Thus, the appearance of the phrases “in one embodiment” or “in an embodiment” in various places throughout this specification does not necessarily mean that the phrases all refer to the same embodiment. The particular features, structures, or characteristics can be combined in any suitable manner in one or more embodiments.

The terms used in the following claims should not be construed to limit embodiments of the invention to the specific embodiments disclosed in the specification and the claims. Rather, the scope of embodiments of the invention is to be determined entirely by the following claims, which are to be construed in accordance with established doctrines of claim interpretation.

1. An apparatus, comprising:
an integrated circuit having:
N queues to receive commands for a memory device, the memory device having M banks, the N queues having a first queue and a second queue to map to a first bank; and
logic to:
determine a last type of command de-queued,
determine a bank designated to receive a next command to be de-queued,
inspect the first and the second queues for a type of command matching the last type of command de-queued,
de-queue the command that matches the last type of command de-queued, and
send the de-queued command to the designated bank.

2. The apparatus of claim 1, wherein the designated bank is the next sequential bank.

3. The apparatus of claim 1, wherein the N queues further include:
a third queue and a fourth queue to map to a second bank;
a fifth queue and a sixth queue to map to a third bank; and
a seventh queue and an eighth queue to map to a fourth bank.

4. The apparatus of claim 3, wherein the memory device is located in a memory module having a first side and a second side, and wherein the first queue, the second queue, the third queue, and the fourth queue map to the first side.

5. The apparatus of claim 4, wherein the fifth queue, the sixth queue, the seventh queue, and the eighth queue map to the second side.

6. An article of manufacture, comprising a machine-accessible medium including data that, when accessed by a machine, cause the machine to perform the operations comprising:
receiving commands in N queues for a memory device, the memory device having M banks, the N queues having a first queue and a second queue to map to a first bank; and
determining a last type of command de-queued;
determining a bank designated to receive a next command to be de-queued;
inspecting first and second queues for a type of command matching the last type of command de-queued;
de-queuing the command that matches the last type of command de-queued; and
sending the de-queued command to the designated bank.

7. The article of manufacture of claim 6, wherein the machine-accessible medium further includes data that cause the machine to perform operations comprising determining a last bank to receive a command and sending the de-queued command to a next sequential bank.

8. The article of manufacture of claim 6, wherein the machine-accessible medium further includes data that cause the machine to perform operations comprising:
mapping a third queue and a fourth queue to a second bank;
mapping a fifth queue and a sixth queue to a third bank; and
mapping a seventh queue and an eighth queue to a fourth bank.

9. The article of manufacture of claim of claim 8, wherein the machine-accessible medium further includes data that cause the machine to perform operations comprising mapping the first queue, the second queue, the third queue, and the fourth queue map to a first side of a memory module on which the memory device is located.

10. The article of manufacture of claim of claim 9, mapping the fifth queue, the sixth queue, the seventh queue, and the eighth queue to a second side of the memory module.

11. A system, comprising:
an integrated circuit having:
N queues to receive commands for a memory device, the memory device having M banks, the N queues having a first queue and a second queue to map to a first bank; and
logic to determine a last type of command de-queued, determine a bank designated to receive a next command to be de-queued, inspect the first and the second queues for a type of command matching the last type of command de-queued, de-queue the command that matches the last type of command de-queued, and send the de-queued command to the designated bank; and
a dual in-line memory module (DIMM) having the designated bank, the memory module to receive the de-queued command.

12. The system of claim 11, wherein the dual in-line memory module (DIMM) is a single-sided memory module.

13. The system of claim 11, wherein the dual in-line memory module (DIMM) is a multiple-sided memory module.

14. An apparatus, comprising:
an integrated circuit having:
N queues to receive commands for a memory device, the memory device having M banks, the N queues having a first queue and a second queue to map to a first bank; and
logic to:
determine a last type of command de-queued,
determine a bank designated to receive a next command to be de-queued, wherein the designated bank is the next sequential bank after a bank to receive a last de-queued command,
inspect the first and the second queues for a type of command matching the last type of command de-queued,
de-queue the command that matches the last type of command de-queued, and
send the de-queued command to the designated bank.

15. The apparatus of claim 14, wherein the N queues further include:
a third queue and a fourth queue to map to a second bank;
a fifth queue and a sixth queue to map to a third bank; and
a seventh queue and an eighth queue to map to a fourth bank.

16. The apparatus of claim 15, wherein the memory device is located in a memory module having a first side and a second side, and wherein the first queue, the second queue, the third queue, and the fourth queue map to the first side.

17. The apparatus of claim 16, wherein the fifth queue, the sixth queue, the seventh queue, and the eighth queue map to the second side.

18. The apparatus of claim 14, wherein the integrated circuit further includes logic to determine that the memory device includes four banks.

19. The apparatus of claim 14, wherein the integrated circuit further includes logic to determine that the memory device includes eight banks.

20. The apparatus of claim 14, wherein the integrated circuit further includes logic to determine that the memory module includes one side.

21. The apparatus of claim 14, wherein the integrated circuit further includes logic to determine that the memory module includes two sides.
